(19) United States
(12) Patent Application Publication
(10) Pub. No.: US 2026/0067471 A1
(43) Pub. Date: Mar. 5, 2026

(54) MOTION COMPENSATION BOUNDARY PADDING

(71) Applicant: Telefonaktiebolaget LM Ericsson (publ), Stockholm (SE)

(72) Inventors: Ruoyang YU, Täby (SE); Kenneth ANDERSSON, Gävle (SE)

(73) Assignee: Telefonaktiebolaget LM Ericsson (publ), Stockholm (SE)

(21) Appl. No.: 19/104,993

(22) PCT Filed: Jul. 31, 2023
(86) PCT No.: PCT/SE2023/050761

§ 371 Date: Feb. 19, 2025

Related U.S. Application Data
(60) Provisional application No. 63/373,092, filed on Aug. 22, 2022.

(51) Int. Cl. H04N 19/167; H04N 19/105; H04N 19/172; H04N 19/176

(52) U.S. Cl. CPC H04N 19/167; H04N 19/105; H04N 19/172; H04N 19/176

(57) ABSTRACT

There is provided a method for creating an extended picture area for a current picture comprising a picture boundary block coded with at least a first motion vector and a second motion vector. The method comprises, based on the first motion vector, determining a position of a first reference block, wherein the first reference block is located within a first reference picture. The method comprises determining a first distance, the first distance being a distance from a boundary of the first reference block to a corresponding boundary of the first reference picture. The method comprises, based on the first distance, determining a first candidate dimension for a picture padding block within the extended picture area. The method comprises, based on the second motion vector, determining a position of a second reference block. The method comprises determining a second distance, the second distance being a distance from a boundary of the second reference block to a corresponding boundary of a reference picture in which the second reference block is located. The method comprises, based on the second distance, determining a second candidate dimension for the picture padding block. The method comprises selecting a candidate dimension from a set of two or more candidate dimensions, the set of two or more candidate dimensions including the first candidate dimension and the second candidate dimension. The method comprises, if the selected candidate dimension is greater than zero, determining at least one sample for the picture padding block based on a motion vector associated with the selected candidate dimension.

### TECHNICAL FIELD

Disclosed are embodiments related to video encoding and decoding.

### BACKGROUND

### 1. Versatile Video Coding (VVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. VVC and HEVC are similar in many aspects. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original sample data and the predicted sample data, referred to as the residual, is transformed into the frequency domain, quantized and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### 2. Components

A video sequence consists of a series of pictures where each picture consists of one or more components. A picture in a video sequence is sometimes denoted ‘image’ or ‘frame’. Each component in a picture can be described as a two-dimensional rectangular array of sample values (or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### 3. Coding Units and Coding Blocks

In many video coding standards, such as HEVC and VVC, each component of a picture is split into blocks and the coded video bitstream consists of a series of coded blocks. A block is a two-dimensional array of samples. It is common in video coding that the picture is split into units that cover a specific area of the picture.

Each unit consists of all blocks from all components that make up that specific area and each block belongs fully to one unit. The macroblock in H.264 and the Coding unit (CU) in HEVC and VVC are examples of units. In VVC the CUs may be split recursively to smaller CUs. The CU at the top level is referred to as the coding tree unit (CTU).

A CU usually contains three coding blocks, i.e. one coding block for luma and two coding blocks for chroma. The size of luma coding block is the same as the CU. The maximum CU size (maxCUwidth) is signaled in a parameter set. In the current VVC (i.e. version 1), the CUs can have size of 4×4 up to 128×128.

### 4. Parameter Sets, Slice Headers and Picture Headers

VVC specifies three types of parameter sets, the picture parameter set (PPS), the sequence parameter set (SPS) and the video parameter set (VPS). The PPS contains data that is common for a whole picture, the SPS contains data that is common for a coded layer video sequence (CLVS) and the VPS contains data that is common for multiple CLVSs, e.g. data for multiple layers in the bitstream.

The concept of slices divides the picture into independently coded slices, where decoding of one slice in a picture is independent of other slices of the same picture. Each slice has a slice header comprising syntax elements. Decoded slice header values from these syntax elements are used when decoding the slice.

In VVC, a coded picture contains a picture header. The picture header contains parameters that are common for all slices of the coded picture.

### 5. Intra Prediction

In intra prediction, also known as spatial prediction, a block is predicted using the previous decoded blocks within the same picture. The samples from the previously decoded blocks within the same picture are used to predict the samples inside the current block. A picture consisting of only intra-predicted blocks is referred to as an intra picture.

### 6. Inter Prediction

In inter prediction, also known as temporal prediction, blocks of the current picture are predicted using blocks from previously decoded pictures. The samples from blocks in the previously decoded pictures are used to predict the samples inside the current block.

A picture that allows inter-predicted block is referred to as an inter picture. The previous decoded pictures used for inter prediction are referred to as reference pictures.

The location of the referenced block inside the reference picture is indicated using a motion vector (MV). Each MV consists of x and y components which represents the displacements between current block and the referenced block in x or y dimension. The value of a component may have a resolution finer than an integer position. When that is the case, a filtering (typically interpolation) is done to calculate values used for prediction. FIG. 7 shows an example of a MV for the current block C.

An inter picture may use several reference pictures. The reference pictures are usually put into two reference picture lists, L0 and L1. The reference pictures that are output before the current picture are typically the first pictures in L0. The reference pictures that are output after the current picture are typically the first pictures in L1.

Inter predicted blocks can use one of two prediction types, uni-and bi-prediction. Uni-predicted block predicts from one reference picture, either using L0 or L1. Bi-prediction predicts from two reference pictures, one from L0 and the other from L1. FIG. 8 shows an example of the prediction types.

### 7. Fractional MVs, Interpolation Filter

The value of a motion vector's (MV's) x or y component may correspond to a sample position which has finer granularity than integer (sample) position. Those positions are also referred to as fractional (sample) positions.

In VVC, the MV can be at 1/16 sample position. FIG. 9A depicts several fractional positions in the horizontal (x-) dimension. The solid-square blocks represent integer positions. The circles represent 1/16-position. For example, MV=(4, 10) means the x component is at 4/16 position, the y component is at 10/16 position.

When a MV is at a fractional position, filtering (typically interpolation) is done to calculate the sample values at those positions. In VVC, the length (number of filter taps) of the interpolation filter for luma component is 8, as shown in the table below.

| Fractional | | | | | | | | |
|---|---|---|---|---|---|---|---|---|
| sample | interpolation filter coefficients | | | | | | | |
| position p | f_{L}[p][0] | f_{L}[p][1] | f_{L}[p][2] | f_{L}[p][3] | f_{L}[p][4] | f_{L}[p][5] | f_{L}[p][6] | f_{L}[p][7] |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

### 8. Reference Picture Resampling (RPR)

RPR is a VVC tool that can be used to enable switching between different resolutions in a video bitstream without encoding a startup of a new sequence with an intra picture. This gives more flexibility to adapt resolution to control bitrate which can be of used in for example video conferencing or adaptive streaming. RPR can make use of previously encoded pictures of lower or higher resolution than the current picture to be encoded by re-scaling them to the resolution of the current picture as part of inter prediction of the current picture.

### 9. Motion Compensated Picture Boundary Padding

In VVC, after encoding or decoding a picture, the picture can be used for reference to predict another picture, and the picture can be extended with an extended picture area (see FIG. 9B for an example) to thereby create an extended picture. The extended picture area is an area surrounding the picture in each direction of the picture boundary. A dimension (width or height in samples) of the extended area is usually set to be with a size of (maxCUwidth+16). The samples in the extended area are derived by repetitive boundary padding. In other words, it is a repetitive copy of a line or a column of picture boundary samples.

When a reference block locates partially or completely out of the picture boundary, the repetitive padded sample is used for motion compensation (MC), which provides better prediction efficiency than disallowing referencing such blocks. This means simply to increase the size of the reference pictures such that MC of a current picture can reference an extended picture area instead of the actual picture area of a previous picture. This could be performed on the fly when referencing a previous picture or as a pre-compute of the current picture before storing it in the decoded picture buffer for reference.

The current Enhanced Compression Model (ECM) includes a method called “motion compensated picture boundary padding.” The method tries to find a group of samples from a reference picture and use those samples for padding or extending the current picture. The motivation is that the samples from reference pictures may contain more structure information than the samples coming from repetitive picture padding of the picture boundary of a current picture. To enable this, it is preferred to do this after encoding and decoding the current picture and basically perform some additional MC to produce an extension of the current picture such that it can be used for reference of inter prediction of following pictures in decoding order.

For motion compensated picture boundary padding, MV of a 4×4 picture boundary block is utilized to derive a M×4 or 4×M motion compensated (MC) picture padding block. The value M is derived as the distance L of the reference block to the reference picture boundary. FIG. 10 shows a picture boundary block (denoted “A”) which has its left boundary colliding with the left boundary of the current picture (i.e., the left boundary of block A is coextensive with a portion of the left boundary of the current picture). As shown in FIG. 10, the reference block in the reference picture is denoted “B.” The distance L shown in FIG. 10 is measured as the distance (in sample) from the left boundary of the reference block B to the left boundary of the reference picture. The samples within an area marked with B_R in the reference picture (a.k.a., “reference padding block”) is then used for generating a motion compensated picture padding block A_P associated with the picture boundary block A (or “boundary block A” or “block A”).

FIG. 11 shows a picture boundary block C which has its top boundary colliding with the top boundary of the current picture. The reference block of the block C in the reference picture is D. The distance L is measured as the distance (in sample) from the top boundary of the reference block D to the top boundary of the reference picture. The samples within the reference padding block (denoted D_R) in the reference picture is then used for generating a motion compensated picture padding block C_P associated with the boundary block C. As illustrated in FIGS. 10 and 11 the reference padding block is a block immediately adjacent to the reference block and extends towards the corresponding reference picture boundary (i.e., the reference padding block and the reference block share a boundary that is parallel with the corresponding reference picture boundary.

If M is less than the desired extended picture area size, the rest of the extended picture area is filled with the repetitive padded samples. When the picture boundary block is intra coded, then its MV is not available, and M is set equal to 0. When the picture boundary block is a bi-predictive inter block, its MV that points to the sample position farther away from the picture boundary in the reference picture in terms of the padding direction, is used in motion compensated picture boundary padding.

### SUMMARY

Certain challenges presently exist. For instance, existing motion compensation boundary padding does not work when the reference block is from a reference picture with a picture resolution different from the current picture (i.e., under RPR scenarios).

Accordingly, in one aspect there is provided a method for creating an extended picture area for a current picture comprising a picture boundary block coded with at least a first motion vector and a second motion vector. The method comprises, based on the first motion vector, determining a position of a first reference block, wherein the first reference block is located within a first reference picture. The method also comprises determining a first distance, the first distance being a distance from a boundary of the first reference block to a corresponding boundary of the first reference picture. The method also comprises, based on the first distance, determining a first candidate dimension (width or height) for a picture padding block within the extended picture area. The method also comprises, based on the second motion vector, determining a position of a second reference block. The method also includes determining a second distance, the second distance being a distance from a boundary of the second reference block to a corresponding boundary of a reference picture in which the second reference block is located (e.g., the second reference block is located within a second reference picture or possibly the first reference picture). The method also comprises, based on the second distance, determining a second candidate dimension (width or height) for the picture padding block. The method also comprises selecting a candidate dimension from a set of two or more candidate dimensions, the set of two or more candidate dimensions including the first candidate dimension and the second candidate dimension. The method also comprises determining at least one sample for the picture padding block based on a motion vector associated with the selected candidate dimension if the selected candidate dimension is greater than zero.

In another aspect there is provided a method for creating an extended picture area for a current picture comprising a picture boundary block coded with a single motion vector. The method comprises, based on the motion vector, determining a position of a reference block, wherein the reference block is located within a reference picture. The method also comprises determining a distance, the distance being a distance from a boundary of the reference block to a corresponding boundary of the reference picture. The method also comprises, based on the distance, determining a dimension (width or height) for a picture padding block within the extended picture area. The method also comprises determining at least one sample for the picture padding block based on the motion vector if the dimension is greater than zero.

In another aspect there is provide a method for creating an extended picture area for a current picture, the current picture comprising a picture boundary block that a) is coded with a set of one or more motion vectors and b) collides with a picture boundary of the current picture, wherein the set of motion vectors comprises a first motion vector. The method comprises determining whether a first reference padding block corresponding to the first motion vector satisfies a first condition, wherein determining whether the first reference padding block satisfies the first condition comprises determining whether the first reference padding block extends beyond a first corresponding reference picture boundary, the first corresponding reference picture boundary being a boundary of a first reference picture associated with the first motion vector that corresponds to the picture boundary of the current picture. The method also comprises, after determining that the first reference padding block satisfies the first condition (e.g., the first reference padding block does not extend beyond the first corresponding reference picture boundary), determining at least one sample for a picture padding block within the extended picture area using the first reference padding block.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they enable motion compensated picture boundary padding when the reference block is from a reference picture with a picture resolution different from the current picture.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 illustrates a motion vector.

FIG. 8 illustrates prediction types.

FIG. 9A illustrates several fractional positions in the horizontal (x-) dimension.

FIG. 9B illustrates an extended picture area.

FIG. 10 shows a picture boundary block A which has its left boundary colliding with the left boundary of the current picture.

FIG. 11 shows a picture boundary block C which has its top boundary colliding with the top boundary of the current picture.

FIG. 12 shows a picture boundary block A which has its left boundary colliding with the left boundary of the current picture.

FIG. 13 shows a picture boundary block A which has its right boundary colliding with the right boundary of the current picture.

FIG. 14 shows a picture boundary block A which has its top boundary colliding with the top boundary of the current picture.

FIG. 15 shows a picture boundary block A which has its bottom boundary colliding with the bottom boundary of the current picture.

FIG. 16 is a block diagram of an apparatus according to an embodiment.

### DETAILED DESCRIPTION

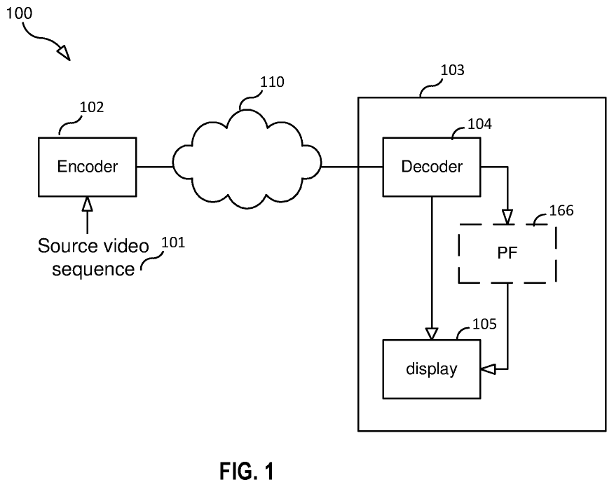

FIG. 1 illustrates a system 100 according to an embodiment. System 100 includes an encoder 102 and a decoder 104, wherein encoder 102 is in communication with decoder 104 via a network 110 (e.g., the Internet or other network). That is, encoder 102 encodes a source video sequence 101 into a bitstream comprising an encoded video sequence and transmits the bitstream to decoder 104 via network 108. In some embodiments, rather than transmitting bitstream to decoder 104, the bitstream is stored in a data storage unit. Decoder 104 decodes the pictures included in the encoded video sequence to produce video data for display and/or post processing. Accordingly, decoder 104 may be part of a device 103 either having a display device 105 or connected to a display device. The device 103 may be a mobile device, a set-top device, a head-mounted display, or any other device. Additionally, as shown in FIG. 1, device 103 may include a post-filter (PF) 166 that receives the decoded picture from decoder 104. In the embodiment shown, post-filter 166 is separate from decoder 104, but in other embodiments, post-filter 166 may be a component of decoder 104.

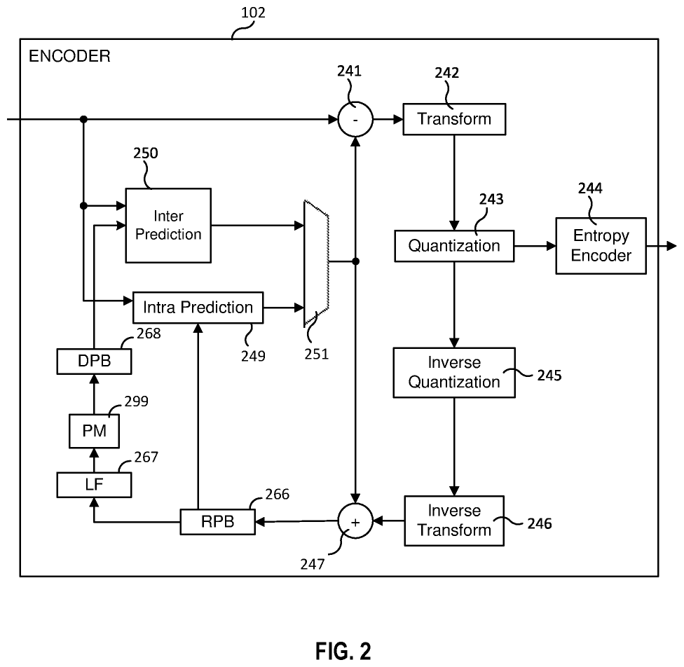

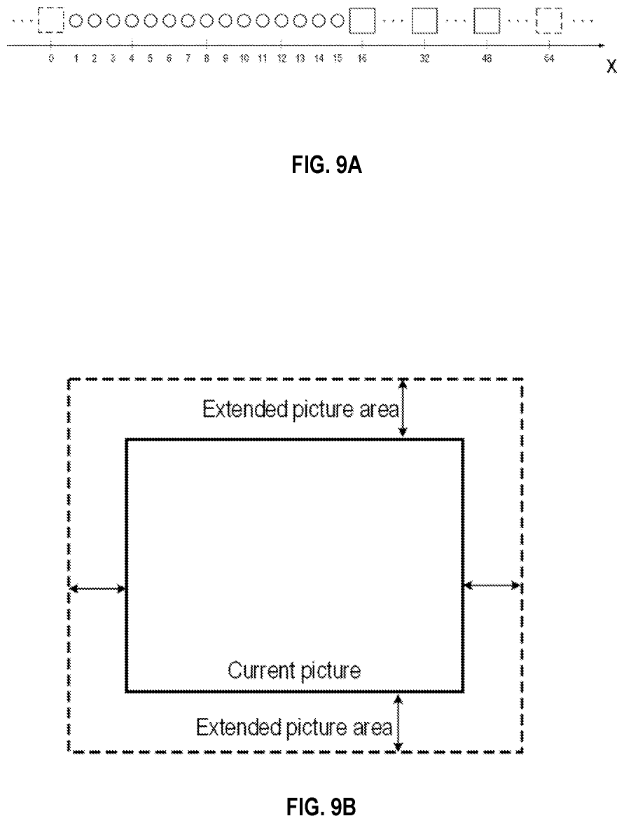

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 and forward quantization 243 is performed on the residual block as well known in the current art. This produces transform coefficients which are then encoded into the bitstream by encoder 244 (e.g., an entropy encoder) and the bitstream with the encoded transform coefficients is output from encoder 102. Next, encoder 102 uses the transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF). In some embodiments, a padding module (PM) 299 is included between the LF 267 and DPB 268, where PM 299 adds an extended picture area to a picture to create an extended picture (see as an example the extended picture shown in FIG. 9B) (i.e. PM 299 may be an ECM component). Alternatively, PM 299 can be placed between DPB 268 and inter prediction module 250.

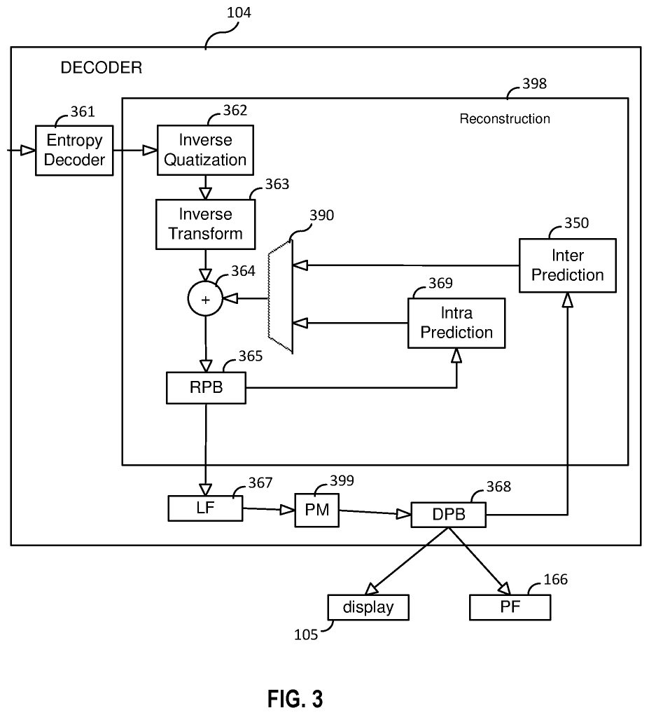

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream transform coefficient values of a block. Decoder 104 also includes a reconstruction stage 398 in which the transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a reconstructed picture buffer (RPB) 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to display 105 and/or PF 166. Pictures are stored in the DPB for two primary reasons: 1) to wait for picture output and 2) to be used for reference when decoding future pictures. In some embodiments, a PM 399 is included between the LF 367 and DPB 368, where PM 399 extends a picture to create an extended picture (see as an example the extended picture shown in FIG. 9B). Alternatively, PM 399 can be placed between DPB 368 and inter prediction module 350.

As described above, a challenge presently exists because existing motion compensation boundary padding does not work when the reference block is from a reference picture with a picture resolution different from the current picture (i.e., under RPR scenarios). This disclosure overcomes this challenge by providing a process that enables the usage of motion compensation boundary padding when RPR is enabled. For example, this disclosure describes determining the size of the padding block considering the difference between the current picture resolution and the reference picture resolution (or alternatively, the RPR scaling ratio).

In one embodiment, there is a process for determining a motion compensated picture padding block A_P for a picture boundary block A within the current picture, where block A has at least one of its boundaries colliding with the current picture boundary. The process can be performed when performing picture padding after decoding or encoding a current picture. The process includes the following steps:

Step 1: determine if the picture boundary block A is coded with at least one motion vector. In other words, determine whether there is at least one motion vector associated with the picture boundary block A. Here the word “associated” means that the motion vector is used for generating the prediction samples of the picture boundary block A.

Step 2: determine a dimension (width or height) for a picture padding block A_P associated with block A. In one embodiment, this step includes the following steps for each motion vector that is associated with the picture boundary block A (e.g., assuming N motion vectors are associated with block A, then the following grouping of steps is performed N times, once for each motion vector):

Step 2a: determine the position of a reference block (B) in a reference picture based on the motion vector (mv_i).

Step 2b: determine a distance (dist_i) from a boundary of the reference block to a corresponding boundary of the reference picture (e.g., distance from left boundary of the reference block to the left boundary of the reference picture or distance from the top boundary of the reference block to the top boundary of the reference picture).

In some embodiments, the determination of the distance (dist_i) of a boundary of the reference block to the corresponding boundary of the reference picture is based on the position of the picture boundary block A relative to the current picture boundary.

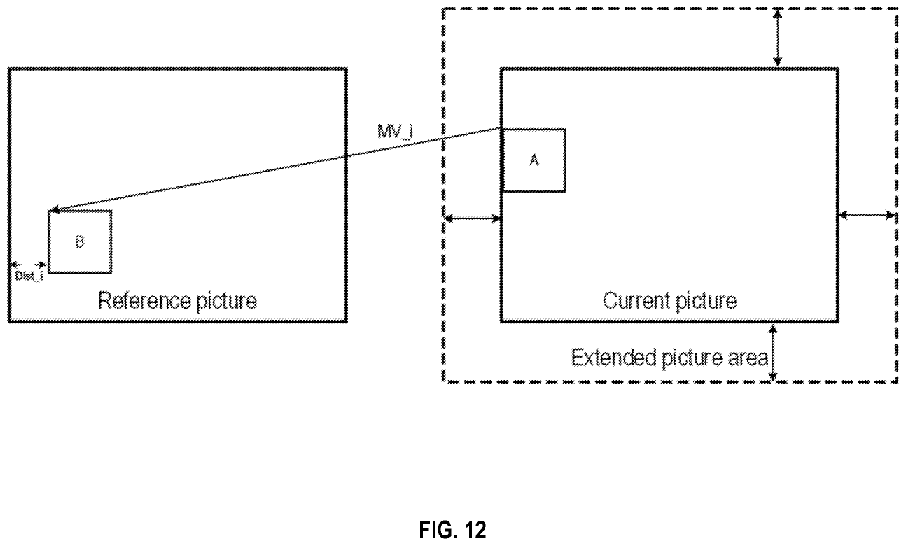

When the block A has its left boundary colliding with the current picture boundary, dist_i is determined as the distance (in sample) from the left boundary of the reference block to the left boundary of the reference picture, as illustrated in FIG. 12.

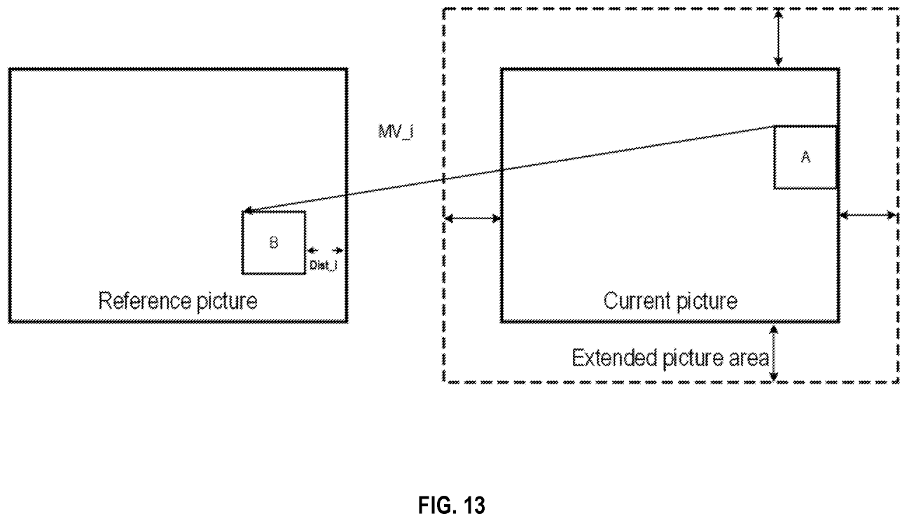

When block A has its right boundary colliding with the current picture boundary, the distance dist_i is determined as the distance (in sample) from the right boundary of the reference block to the right boundary of the reference picture, as illustrated in FIG. 13.

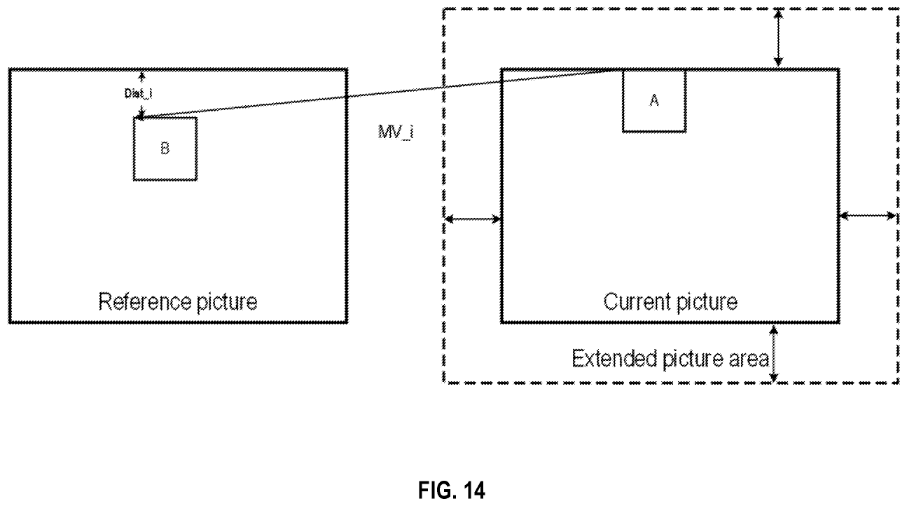

When block A has its top boundary colliding with the current picture boundary, the distance dist_i is determined as the distance (in sample) from the top boundary of the reference block to the top boundary of the reference picture, as illustrated in FIG. 14.

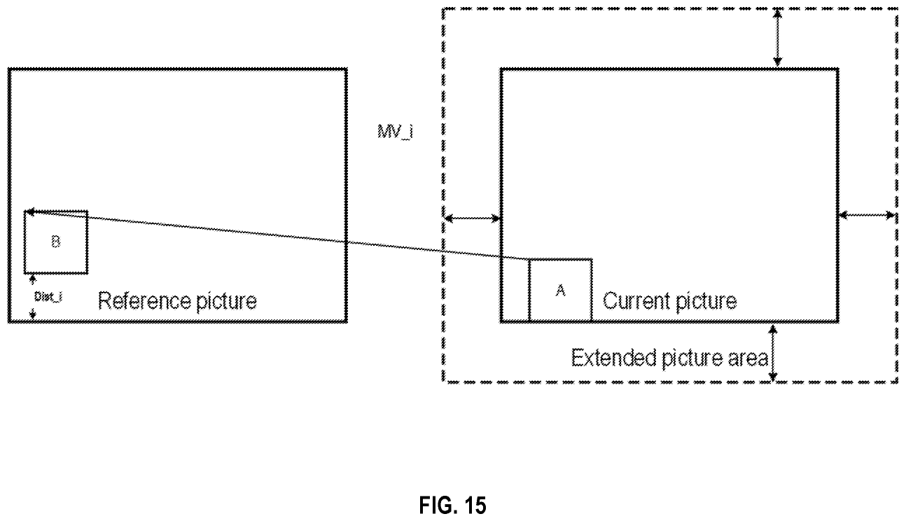

When block A has its bottom boundary colliding with the current picture boundary, the distance dist_i is determined as the distance (in sample) from the bottom boundary of the reference block to the bottom boundary of the reference picture, as illustrated in FIG. 15.

Step 2c: determine a candidate dimension (cand_i) for picture padding block A_P based on dist_i, the current picture resolution, and the reference picture resolution.

After steps 2A-2C are performed N times, there will be N candidate dimensions (i.e., cand_i, for i=1, 2, . . . , N).

Step 3: select one of the N candidate dimensions. For example, select the candidate dimension that is greater than the other candidate dimensions (e.g., select max(cand_1, cand_2, . . . , cand_N)).

Step 4: set a first dimension of the padding block (e.g., width or height) equal to the selected candidate dimension and set the second dimension (e.g., height if the first dimension is width or width if the first dimension is height) to a predetermined value (e.g., 4), thereby establishing the dimensions of the picture padding block A_P.

Step 5: In response to the determination that the selected candidate dimension of the picture padding block A_P is not 0, further determine at least one sample within the associated picture padding block A_P using inter prediction based on the motion vector associated with the selected candidate dimension (the motion vector that gives the maximum value among all the cand_i).

The determination of at least one sample using inter prediction may be as follows:

A_P(x,y)=r(x′+mvX, y′+mvY), where x,y is a coordinate of the picture padding block A_P in the current picture coordinates, x′ and y′ are corresponding coordinates in the reference picture coordinates, mvX is the horizontal motion vector component of the motion vector in reference picture coordinates, mvY is the vertical motion vector component of the motion vector in reference picture coordinates and r(x′+mvX, y′+mvY) is a sample of the reference picture. If the motion vector components correspond to a non-integer value interpolation with filter is needed. The formulas below show an example of the filtering, first horizontally and then vertically on the output of the horizontally filtering.

$$a . t ( {x}^{′′} , {y}^{′′} ) = ( {\sum }_{n = 0}^{N - 1} {f}_{i} ( n ) * r ( {x}^{′} + n - \frac{N}{2} + 1 + mvXInt , {y}^{′} + mvYInt ) ) ≫ P$$

$${r}^{′′} ( x , y ) = ( {\sum }_{n = 0}^{N - 1} {f}_{j} ( n ) * t ( {x}^{′′} , {y}^{′′} + n - \frac{N}{2} + 1 ) ) ≫ R$$

t(x″,y″) is a value of a sample after horizontal filtering, x is a horizontal coordinate and y is a vertical coordinate of a sample in the current picture, x′ is a horizontal coordinate and y′ is a vertical coordinate of a sample in the reference picture, x″ is a horizontal coordinate and y″ is a vertical coordinate of a sample in the temporal buffer t, mvXInt and mvYInt are the motion vectors in the integer resolution that are used to determine the sample to filter in the reference picture r, f_i is the sub-sample filter that corresponds to the fractional position (phase) of mvX and f_i (n) is the filter coefficient at position n of that filter, f_j is the sub-sample filter that corresponds to the fractional position (phase) of mvY and f_j (n) is the filter coefficient at position n of that filter, r(A,B) is the value of a sample in the reference picture at the location (A,B), and Nis filter length (i.e., the number of taps). P and R are constants used for shifting.

r″(x,y) is a sample that has both been horizontally and vertically filtered, e.g., a sample obtained using the inter prediction that is based on fractional sample interpolation of samples from a reference picture (previously reconstructed picture). As shown above, before the vertical filtering is applied, the horizontal filtering is applied for all samples that are needed for vertical filtering.

### Determination of cand_i

In one embodiment, cand_i is set to 0 if the current picture resolution is different than the resolution of the reference picture. Otherwise (the current picture resolution and the reference picture resolution is the same), the candidate width or height cand_i is determined to be dist_i. For example, if the current block A has only one MV and the MV is with a scaled reference picture (the current picture resolution is different from the reference picture resolution), that would mean the motion compensated picture padding (since the width or height of the associated picture padding block will be 0) is not used for extending the area near current block A but repetitive padding is used instead. As another example, if the current block A has two motion vectors (Mv0 and MV1), let's say MV0 is with a scaled reference picture, MV1 is with a non-scaled reference picture, then the candidate width or height cand_0 for MV0 will be 0, the cand_1 for MV1 will be dist_1. This means the MV1 is prioritized to be used for motion compensated picture padding (since the cand_1 will be dist_1 and a maximum operation is used for selecting which MV to use based on all cand_i).

In another embodiment, when block A has its left or right boundary colliding with the current picture boundary, cand_i is set 0 if the width of the current picture is different than the width of the reference picture. In this embodiment, cand_i is a width dimension.

In another embodiment, when block A has its top or bottom boundary colliding with the current picture boundary, cand_i is set to 0 if the height of the current picture is different than the height of the reference picture. In this embodiment, cand_i is a height dimension.

In another embodiment, when block A has the left boundary or right boundary colliding with the picture boundary, cand_i is derived based on dist_i and the ratio between the current picture width and the reference picture width (a.k.a., RPR scaling ratio).

In another embodiment, cand_i equals to T=dist_i*CurD/RefD, where CurD is a dimension (e.g., height or width) of the current picture and RefD is a corresponding dimension of the reference picture. More specifically, if the candidate dimension (cand_i) is a width value then CurD and RefD are the widths of the current picture and reference picture, respectively. Similarly, if the candidate dimension (cand_i) is a heigh value then CurD and RefD are the heights of the current picture and reference picture, respectively.

In another embodiment, cand_i is set to (Floor(T/X)*X). In other words, the cand_i is set to an integer value that is equal to or less than T and dividable by X. In one example, X=4.

### Additional Embodiments

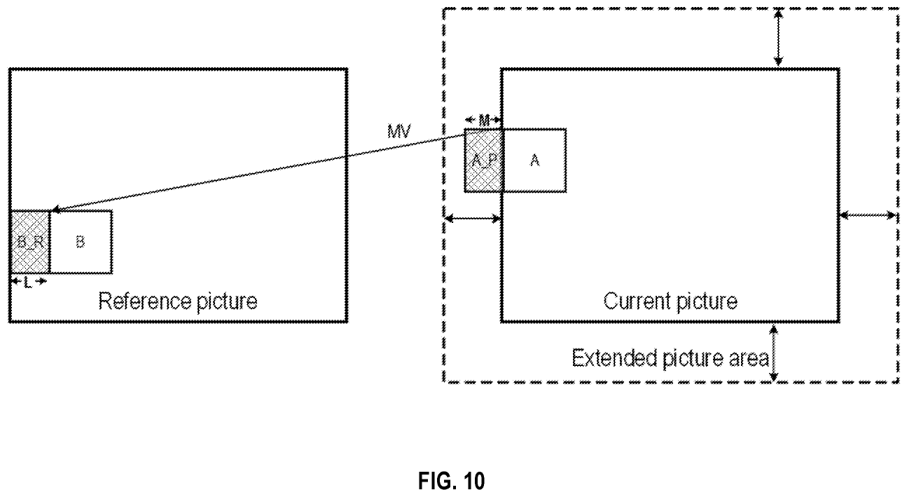

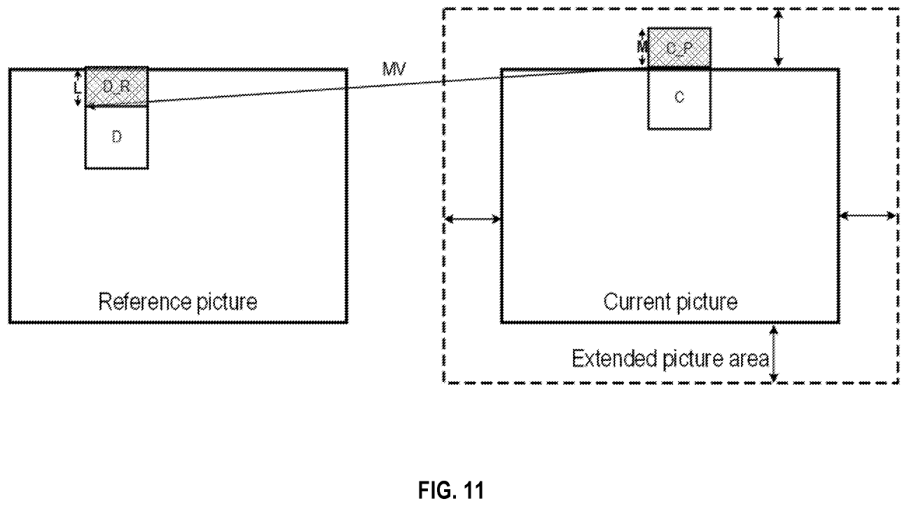

In another embodiment, for each motion vector associated with the picture boundary block (e.g., block A shown in FIG. 10 or block C shown in FIG. 11) there is a check to determine if the reference padding block corresponding to the motion vector (i.e., the reference padding block adjacent to the reference block identified by the motion vector (e.g., block B_R shown in FIG. 10 or block D_R in FIG. 11)) extends beyond the “corresponding reference picture boundary”—i.e., the boundary of the reference block (i.e., the block containing at least a portion of the reference block) corresponding to the boundary of the current picture with which the picture boundary block collides. For example, if the picture boundary block collides with the left boundary of the current block, then the corresponding reference picture boundary is the left boundary of the reference block. Likewise, if the picture boundary block collides with the right/top/bottom boundary of the current block, then the corresponding reference picture boundary is the right/top/bottom boundary, respectively, of the reference block.

This condition can be checked using the component of the motion vector in current picture resolution that is orthogonal to the current picture boundary with which the picture boundary block collides. That is, if the picture boundary block collides with the left or right boundary of the current picture, then the horizontal (or “x”) component of the motion vector is orthogonal to the current picture boundary which the picture boundary block collides. Similarly, if the picture boundary block collides with the top or bottom boundary of the current picture, then the vertical (or “y”) component of the motion vector is orthogonal to the current picture boundary which the picture boundary block collides.

For this discussion, we assume that that a positive value of the horizontal motion vector means a shift to the right by an amount proportional to the value and a negative value means a shift to the left proportional to the value, and a positive value of the vertical motion vector means a shift downwards proportional to the value and a negative value means a shift upwards proportional to the value.

With this assumption, if the picture boundary block collides with the left boundary and the x component of the MV in current picture resolution is greater than or equal to the width of the picture padding block, then it is determined that the reference padding block corresponding to the MV does not extend beyond the corresponding reference picture boundary; and if the picture boundary block collides with the right boundary and the x component of the MV in current picture resolution is less than or equal to (−1*width) of the picture padding block, then it is determined that the reference padding block corresponding to the MV does not extend beyond the corresponding reference picture boundary.

In one embodiment, the width of the picture padding block is predefined as 16 or at least the interpolation filter length divided by 2, and the height of the picture padding block is 4 or at least not smaller than the smallest block size. In another embodiment, if the picture boundary block collides with the left boundary and if the x component is less than 4, then the width (W) of the picture padding block is set to 0; if the picture boundary block collides with the left boundary and if the x component is not less than 4, then W is set to: min(16, x); if the picture boundary block collides with the right boundary and if the x component is greater than −4, then the width (W) of the picture padding block us set to 0; if the picture boundary block collides with the right boundary and if the x component is not greater than −4 then W is set to: −1*max (−16, x).

Similarly, given the above assumption, if the picture boundary block collides with the top boundary and the y component of the MV in current picture resolution is greater than or equal to the height the picture padding block, then it is determined that the reference padding block corresponding to the MV does not extend beyond the corresponding reference picture boundary; and if the picture boundary block collides with the bottom boundary and the y component of the MV in current picture resolution is less than or equal to (−1*height) of the picture padding block, then it is determined that the reference padding block corresponding to the MV does not extend beyond the corresponding reference picture boundary.

In one embodiment, the height of the picture padding block is predefined as 16 or at least the interpolation filter length divided by 2, and the width of the picture padding block is 4or at least not smaller than the smallest block size. In another embodiment, if the picture boundary block collides with the top boundary and the y component is less than 4, then the height (H) of the picture padding block is set to 0, otherwise H is set to: min(16, y). If the picture boundary block collides with the bottom boundary then if the y component is greater than-4 then the height (H) of the picture padding block us set to 0, otherwise H is set to: −1*max(−16, y).

In one embodiment, if at least one reference padding block does not extend beyond the corresponding reference picture boundary, then the picture padding block is padded based on MC, otherwise repetitive padding is used. Accordingly, in this embodiment, the process for determining the picture padding block (e.g. A_P, B_P, C_P or D_P) for the corresponding picture boundary block (e.g., A, B, C or D, respectively) includes the following steps:

Step 1: determine if the picture boundary block is coded with at least one motion vector. In other words, determine whether there is at least one motion vector associated with the picture boundary block.

Step 2: for each motion vector that is associated with the picture boundary block, determine whether the reference padding block corresponding to the reference block identified by the motion vector extends beyond the corresponding reference picture boundary. In one embodiment, this step can be performed as described above.

Step 3: If one or more of the reference padding blocks do not extend beyond their corresponding reference picture boundary, then determine at least one sample for the padding block using inter prediction based on at least one of said one or more reference padding blocks. For example, in one embodiment only a single reference padding block is used. In the embodiment in which only a single reference padding block is used, if two or more reference padding blocks (RPBs) does not extend beyond their corresponding reference picture boundary, then select a RPB that is in reference picture having same resolution as the current picture, otherwise either select the RPB using a rule know to both the encoder and decoder. One example rule can be to select the motion vector that corresponds to the reference picture which is temporally closes to the current picture.

If you have two (or more) reference padding blocks that do extend beyond their corresponding reference picture boundary, then one may determine a padding sample based on an average of samples from the two or more reference padding blocks.

The determination of at least one sample for the padding block A_P using inter prediction may be as follows:

A_P(x,y)=r(x′+mvX, y′+mvY), where x,y is a coordinate of the picture padding block A_P in the current picture coordinates, x′ and y′ are corresponding coordinates in the reference picture coordinates, mvX is the horizontal motion vector component of the motion vector mv_i in reference picture coordinates, mvY is the vertical motion vector component of the motion vector mv_i in reference picture coordinates, and r(x′+mvX, y+mvY) is a sample of the reference picture. If the motion vector components correspond to a non-integer value interpolation with filter is needed. The formulas below show an example of the filtering, first horizontally and then vertically on the output of the horizontally filtering.

$$a . t ( {x}^{′′} , {y}^{′′} ) = ( {\sum }_{n = 0}^{N - 1} {f}_{i} ( n ) * r ( {x}^{′} + n - \frac{N}{2} + 1 + mvXInt , {y}^{′} + mvYInt ) ) ≫ P$$

$$b . {r}^{′′} ( x , y ) = ( {\sum }_{n = 0}^{N - 1} {f}_{j} ( n ) * t ( {x}^{′′} , {y}^{′′} + n - \frac{N}{2} + 1 ) ) ≫ R$$

t(x″,y″) is a value of a sample after horizontal filtering, x is a horizontal coordinate and y is a vertical coordinate of a sample in the current picture, x′ is a horizontal coordinate and y′ is a vertical coordinate of a sample in the reference picture, x″ is a horizontal coordinate and y″ is a vertical coordinate of a sample in the temporal buffer t, mvXInt and mvYInt are the motion vectors in the integer resolution that are used to determine the sample to filter in the reference picture r, f_i is the sub-sample filter that corresponds to the fractional position (phase) of mvX and f_i (n) is the filter coefficient at position n of that filter, f_j is the sub-sample filter that corresponds to the fractional position (phase) of mvY and f_j (n) is the filter coefficient at position n of that filter, r(A,B) is the value of a sample in the reference picture at the location (A,B), and Nis filter length (i.e., the number of taps).). P and R are constants used for shifting.

r″(x,y) is a sample that has both been horizontally and vertically filtered, e.g., a sample obtained using the inter prediction that is based on fractional sample interpolation of samples from a reference picture (previously reconstructed picture). As shown above, before the vertical filtering is applied, the horizontal filtering is applied for all samples that are needed for vertical filtering.

In one embodiment, step 3 is modified such that the step of determining at least one sample for the padding block A_P based on at least one of said one or more reference padding blocks is performed only if at least one of the RPBs that does not extend beyond its corresponding reference picture boundary is in a reference picture having the same resolution as the current picture, otherwise use repetitive padding.

Step 4: If no reference padding block is inside the reference picture, then repetitive padding is used.

The size of block A_P can for example be one of 4×4, 4×8, 8×4, 4×16, 16×4, 8×8 or 16×16.

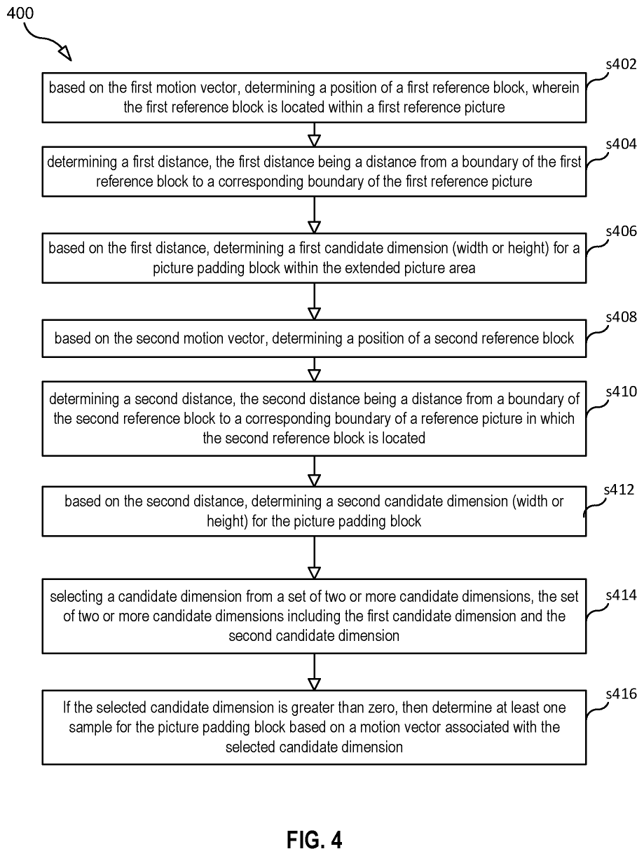

FIG. 4 is a flowchart illustrating a process 400 for creating an extended picture area for a current picture comprising a picture boundary block coded with at least a first motion vector and a second motion vector. Process 400 may begin in step s402.

Step s402 comprises, based on the first motion vector, determining a position of a first reference block, wherein the first reference block is located within a first reference picture.

Step s404 comprises determining a first distance, the first distance being a distance from a boundary of the first reference block to a corresponding boundary of the first reference picture.

Step s406 comprises, based on the first distance, determining a first candidate dimension (width or height) for a picture padding block within the extended picture area.

Step s408 comprises, based on the second motion vector, determining a position of a second reference block.

Step s410 comprises determining a second distance, the second distance being a distance from a boundary of the second reference block to a corresponding boundary of a reference picture in which the second reference block is located (e.g., the second reference block is located within a second reference picture or possibly the first reference picture).

Step s412 comprises, based on the second distance, determining a second candidate dimension (width or height) for the picture padding block.

Step s414 comprises selecting a candidate dimension from a set of two or more candidate dimensions, the set of two or more candidate dimensions including the first candidate dimension and the second candidate dimension.

Step s416 comprises determining at least one sample for the picture padding block based on a motion vector associated with the selected candidate dimension if the selected candidate dimension is greater than zero.

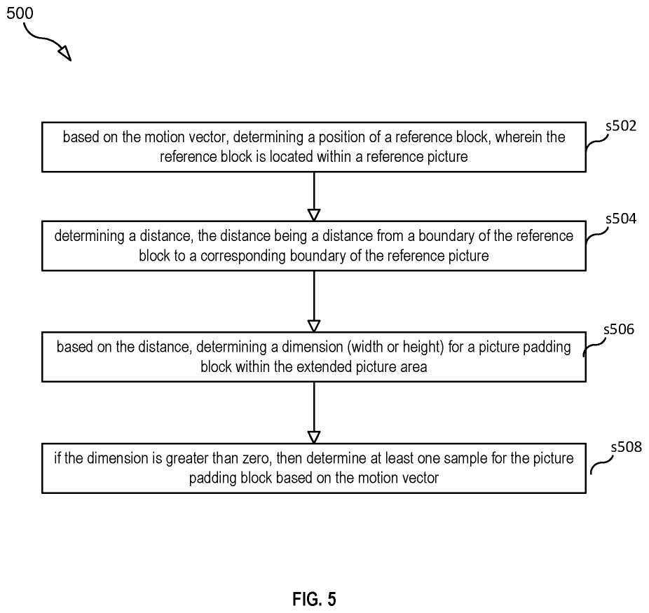

FIG. 5 is a flowchart illustrating a process 500 for creating an extended picture area for a current picture comprising a picture boundary block coded with a single motion vector. Process 500 may begin in step s502.

Step s502 comprises, based on the motion vector, determining a position of a reference block, wherein the reference block is located within a reference picture.

Step s504 comprises determining a distance, the distance being a distance from a boundary of the reference block to a corresponding boundary of the reference picture.

Step s506 comprises, based on the distance, determining a dimension (width or height) for a picture padding block within the extended picture area.

Step s508 comprises determining at least one sample for the picture padding block based on the motion vector if the dimension is greater than zero.

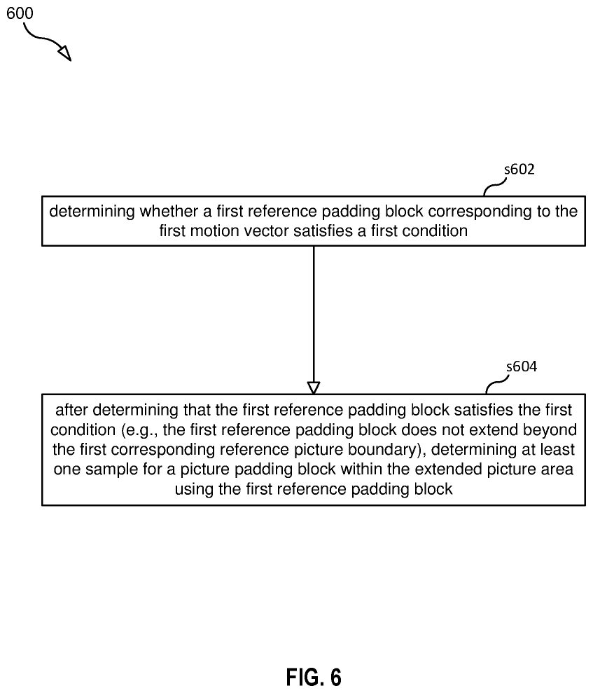

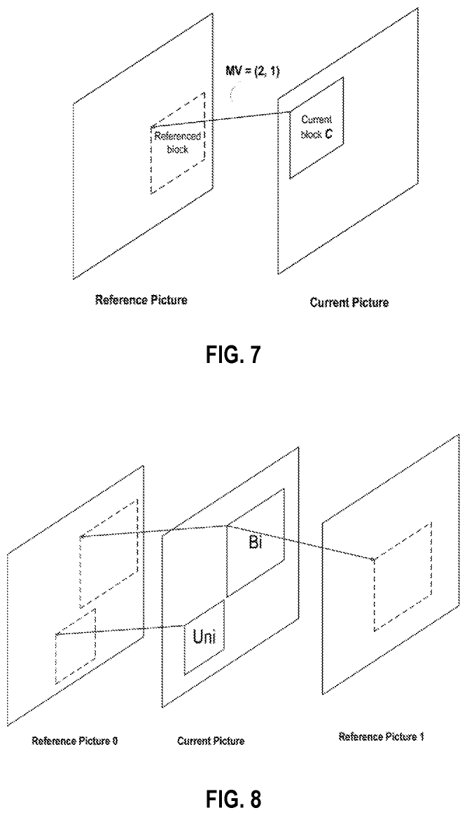

FIG. 6 is a flowchart illustrating a process 600 for creating an extended picture area for a current picture, the current picture comprising a picture boundary block that a) is coded with a set of one or more motion vectors and b) collides with a picture boundary of the current picture, wherein the set of motion vectors comprises a first motion vector. Process 600 may begin in step s602.

Step s602 comprises determining whether a first reference padding block corresponding to the first motion vector satisfies a first condition, wherein determining whether the first reference padding block satisfies the first condition comprises determining whether or not the first reference padding block extends beyond a first corresponding reference picture boundary, the first corresponding reference picture boundary being a boundary of a first reference picture associated with the first motion vector that corresponds to the picture boundary of the current picture.

Step s604 comprises, after determining that the first reference padding block satisfies the first condition (e.g., it is determined that the first reference padding block does not extend beyond the first corresponding reference picture boundary), determining at least one sample for a picture padding block within the extended picture area using the first reference padding block.

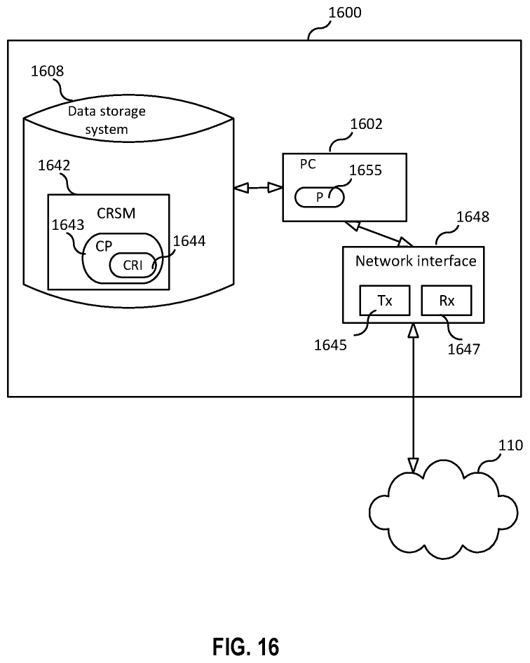

FIG. 16 is a block diagram of an apparatus 1600 for implementing encoder 102 or decoder 104, according to some embodiments. As shown in FIG. 16, apparatus 1600 may comprise: processing circuitry (PC) 1602, which may include one or more processors (P) 1655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1600 may be a distributed computing apparatus); at least one network interface 1648 comprising a transmitter (Tx) 1645 and a receiver (Rx) 1647 for enabling apparatus 1600 to transmit data to and receive data from other nodes connected to a network 160 (e.g., an Internet Protocol (IP) network) to which network interface 1648 is connected (directly or indirectly) (e.g., network interface 1648 may be wirelessly connected to the network 160, in which case network interface 1648 is connected to an antenna arrangement); and a storage unit (a.k.a., “data storage system”) 1608, which may include one or more non-volatile storage devices and/or one or more volatile storage devices. In embodiments where PC 1602 includes a programmable processor, a computer readable storage medium (CRSM) 1642 may be provided. CRSM 1642 stores a computer program (CP) 1643 comprising computer readable instructions (CRI) 1644. CRSM 1642 may be a non-transitory computer readable storage medium, such as, magnetic media (e.g., a hard disk), optical media, memory devices (e.g., random access memory, flash memory), and the like. In some embodiments, the CRI 1644 of computer program 1643 is configured such that when executed by PC 1602, the CRI causes apparatus 1600 to perform steps described herein (e.g., steps described herein with reference to the flow charts). In other embodiments, apparatus 1600 may be configured to perform steps described herein without the need for code. That is, for example, PC 1602 may consist merely of one or more ASICs. Hence, the features of the embodiments described herein may be implemented in hardware and/or software.

### Summary of Various Embodiments

A1. A method 400 (See FIG. 4) for creating an extended picture area for a current picture comprising a picture boundary block coded with at least a first motion vector and a second motion vector, comprising:
based on the first motion vector, determining a position of a first reference block, wherein the first reference block is located within a first reference picture;
determining a first distance, the first distance being a distance from a boundary of the first reference block to a corresponding boundary of the first reference picture;
based on the first distance, determining a first candidate dimension (width or height) for a picture padding block within the extended picture area;
based on the second motion vector, determining a position of a second reference block;
determining a second distance, the second distance being a distance from a boundary of the second reference block to a corresponding boundary of a reference picture in which the second reference block is located (e.g., the second reference block is located within a second reference picture or possibly the first reference picture);
based on the second distance, determining a second candidate dimension (width or height) for the picture padding block;
selecting a candidate dimension from a set of two or more candidate dimensions, the set of two or more candidate dimensions including the first candidate dimension and the second candidate dimension; and
if the selected candidate dimension is greater than zero, then determine at least one sample for the picture padding block based on a motion vector associated with the selected candidate dimension.
A2. The method of embodiment A1, further comprising:
setting a first dimension of the padding block equal to the selected candidate dimension (e.g. set width of the padding block so that the width is equal to the selected candidate dimension); and
setting a second dimension of the padding block (e.g., height if the first dimension is width or width if the first dimension is height) to a predetermined value (e.g., 4).
A3. The method of embodiment A1 or A2, wherein determining the first candidate dimension comprises setting the first candidate dimension to 0 as a result of determining that the resolution of the current picture is different than the resolution of the first reference picture.
A4. The method of embodiment A1 or A2, wherein determining the first candidate dimension comprises setting the first candidate dimension to 0 as a result of i) determining that the width of the current picture is different than the width of the first reference picture and ii) determining that the picture boundary block has its left or right boundary colliding with a boundary of the current picture.
A5. The method of embodiment A1 or A2, wherein determining the first candidate dimension comprises setting the first candidate dimension to 0 as a result of i) determining that the height of the current picture is different than the height of the first reference picture and ii) determining that the picture boundary block has its top or bottom boundary colliding with a boundary of the current picture.
A6. The method of embodiment A1 or A2, wherein determining the first candidate dimension comprises setting the first candidate dimension to a value derived using the first distance, a dimension of the current picture (e.g., the width of the current picture), and a dimension of the first reference picture.
A7. The method of embodiment A6, wherein the value is equal to:
dist_1*CurD/RefD, where
CurD is a dimension (e.g., height or width) of the current picture,
RefD is a corresponding dimension of the first reference picture, and
dist_1 is the first distance.
A8. The method of embodiment A6, wherein the value is equal to
Floor ((dist_1*CurD/RefD)/X)*X, where
CurD is a dimension (e.g., height or width) of the current picture,
RefD is a corresponding dimension of the first reference picture,
dist_1 is the first distance, and
X is a predetermined integer (e.g. X=4).
A9. The method of any one of embodiments A1-A8, wherein selecting the candidate dimension from a set of two or more candidate dimensions comprises:
comparing the first candidate dimension to the second candidate dimension;
if the first candidate dimension is larger than the second candidate dimension, selecting the first candidate dimension;
if the second candidate dimension is larger than the first candidate dimension, selecting the second candidate dimension; and
if the first candidate dimension is equal to the second candidate dimension, selecting either the first candidate dimension or the second candidate dimension.
B1. A method 500 (See FIG. 5) for creating an extended picture area for a current picture comprising a picture boundary block coded with a single motion vector, comprising:
based on the motion vector, determining a position of a reference block, wherein the reference block is located within a reference picture;
determining a distance, the distance being a distance from a boundary of the reference block to a corresponding boundary of the reference picture;
based on the distance, determining a dimension (width or height) for a picture padding block within the extended picture area;
if the dimension is greater than zero, then determine at least one sample for the picture padding block based on the motion vector.
B2. The method of embodiment B1, further comprising:
setting a first dimension of the padding block equal to the determined dimension (e.g. set width of the padding block so that the width is equal to the determined dimension); and
setting a second dimension of the padding block (e.g., height if the first dimension is width or width if the first dimension is height) to a predetermined value (e.g., 4).
B3. The method of embodiment B1 or B2, wherein determining the dimension comprises setting the dimension to 0 as a result of determining that the resolution of the current picture is different than the resolution of the reference picture.
B4. The method of embodiment B1 or B2, wherein determining the dimension comprises setting the dimension to 0 as a result of i) determining that the width of the current picture is different than the width of the reference picture and ii) determining that the picture boundary block has its left or right boundary colliding with a boundary of the current picture.
B5. The method of embodiment B1 or B2, wherein determining the dimension comprises setting the dimension to 0 as a result of i) determining that the height of the current picture is different than the height of the reference picture and ii) determining that the picture boundary block has its top or bottom boundary colliding with a boundary of the current picture.
B6. The method of embodiment B1 or B2, wherein determining the dimension comprises setting the dimension to a value derived using the distance, a dimension of the current picture (e.g., the width of the current picture), and a dimension of the reference picture.
B7. The method of embodiment B6, wherein the value is equal to:
dist*CurD/RefD, where
CurD is a dimension (e.g., height or width) of the current picture,
RefD is a corresponding dimension of the reference picture, and
dist is the distance.
B8. The method of embodiment B6, wherein the value is equal to
Floor ((dist*CurD/RefD)/X)*X, where
CurD is a dimension (e.g., height or width) of the current picture,
RefD is a corresponding dimension of the reference picture,
dist is the distance, and
X is a predetermined integer (e.g. X=4).
C1. A method 600 (see FIG. 6) for creating an extended picture area for a current picture, the current picture comprising a picture boundary block that a) is coded with a set of one or more motion vectors and b) collides with a picture boundary of the current picture, wherein the set of motion vectors comprises a first motion vector, the method comprising:
determining whether a first reference padding block corresponding to the first motion vector satisfies a first condition, wherein determining whether the first reference padding block satisfies the first condition comprises determining whether or not the first reference padding block extends beyond a first corresponding reference picture boundary, the first corresponding reference picture boundary being a boundary of a first reference picture associated with the first motion vector that corresponds to the picture boundary of the current picture; and
after determining that the first reference padding block satisfies the first condition (e.g., the first reference padding block does not extend beyond the first corresponding reference picture boundary), determining at least one sample for a picture padding block within the extended picture area using the first reference padding block.
C2. The method of embodiment C1, further comprising, after determining that the first reference padding block satisfies the first condition and before determining at least one sample for a picture padding block within the extended picture area using the first reference padding block, determining whether the first reference picture has the same resolution as the current picture.
C3. The method of embodiment C2, wherein the step of determining at least one sample for the picture padding block within the extended picture area using the first reference padding block is performed as a result of determining that: a) the first reference padding block satisfies the first condition and b) the first reference picture has the same resolution as the current picture.
C4. The method of embodiment C1, C2, or C3, wherein
the picture boundary block collides with the left boundary of the current picture,
the first motion vector comprises a horizontal component, x, and a vertical component, y, and
determining whether the first reference padding block satisfies the first condition comprises comparing x to the width of the picture padding block (e.g., in one embodiment, the first reference padding block satisfies the first condition iff x≥width).
C5. The method of embodiment C1, C2, or C3, wherein
the picture boundary block collides with the right boundary of the current picture,
the first motion vector comprises a horizontal component, x, and a vertical component, y, and
determining whether the first reference padding block satisfies the first condition comprises comparing x to the negative of the width of the picture padding block (e.g., in one embodiment, the first reference padding block satisfies the first condition iff x is ≤−width).
C6. The method of any one of embodiments C1-C5, further comprising, prior to determining whether the first reference padding block satisfies the first condition, setting the width, W, of the picture padding block, wherein setting the width of the picture padding block comprises:
if the picture boundary block collides with the left picture boundary, then set W=0 if x is less than 4, otherwise set W=min(16,x), or
if the picture boundary collides with the right picture boundary, then set W=0 if x is greater than −4, otherwise set W=−max(—16, x).
C7. The method of embodiment C1, C2, or C3, wherein
the picture boundary block collides with the top boundary of the current picture,
the first motion vector comprises a horizontal component, x, and a vertical component, y, and
determining whether the first reference padding block satisfies the first condition comprises comparing y to the height of the picture padding block (e.g., in one embodiment, the first reference padding block satisfies the first condition iff y≥height).
C8. The method of embodiment C1, C2, or C3, wherein
the picture boundary block collides with the bottom boundary of the current picture,
the first motion vector comprises a horizontal component, x, and a vertical component, y, and
determining whether the first reference padding block satisfies the first condition comprises comparing y to the negative of the height of the picture padding block (e.g., in one embodiment, the first reference padding block satisfies the first condition iff y≤−height).
C9. The method of embodiment C1, C2, C3, C7 or C8, further comprising, prior to determining whether the first reference padding block satisfies the first condition, setting the height, H, of the picture padding block, wherein setting the height of the picture padding block comprises:
if the picture boundary block collides with the top picture boundary, then set H=0 if y is less than 4, otherwise set H=min(16, y), or
if the picture boundary block collides with the bottom picture boundary, then set H=0 if y is greater than −4, otherwise set H=−max(−16, y).
D1. A computer program (1643) comprising instructions (1644) which when executed by processing circuitry (1602) of an apparatus (1600) causes the apparatus to perform the method of any one of the above embodiments.
D2. A carrier containing the computer program of embodiment D1, wherein the carrier is one of an electronic signal, an optical signal, a radio signal, and a computer readable storage medium (1642).
E1. An apparatus (1600) that is configured to perform the method of any one of the above embodiments.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for creating an extended picture area for a current picture comprising a picture boundary block coded with at least a first motion vector and a second motion vector, the method comprising:
based on the first motion vector, determining a position of a first reference block, wherein the first reference block is located within a first reference picture;
determining a first distance, the first distance being a distance from a boundary of the first reference block to a corresponding boundary of the first reference picture;
based on the first distance, determining a first candidate dimension for a picture padding block within the extended picture area;
based on the second motion vector, determining a position of a second reference block;
determining a second distance, the second distance being a distance from a boundary of the second reference block to a corresponding boundary of a reference picture in which the second reference block is located;
based on the second distance, determining a second candidate dimension for the picture padding block;
selecting a candidate dimension from a set of two or more candidate dimensions, the set of two or more candidate dimensions including the first candidate dimension and the second candidate dimension;
determining whether the selected candidate dimension is greater than zero; and
as a result of determining that the selected candidate dimension is greater than zero, determining at least one sample for the picture padding block based on a motion vector associated with the selected candidate dimension.

2. The method of claim 1, wherein the method further comprises:
setting a first dimension of the padding block equal to the selected candidate dimension; and
setting a second dimension of the padding block.

3. The method of claim 1, wherein determining the first candidate dimension comprises setting the first candidate dimension to 0 as a result of determining that the resolution of the current picture is different than the resolution of the first reference picture.

4. The method of claim 1, wherein determining the first candidate dimension comprises setting the first candidate dimension to 0 as a result of i) determining that the width of the current picture is different than the width of the first reference picture and ii) determining that the picture boundary block has its left or right boundary colliding with a boundary of the current picture.

5. The method of claim 1, wherein determining the first candidate dimension comprises setting the first candidate dimension to 0 as a result of i) determining that the height of the current picture is different than the height of the first reference picture and ii) determining that the picture boundary block has its top or bottom boundary colliding with a boundary of the current picture.

6. The method of claim 1, wherein determining the first candidate dimension comprises setting the first candidate dimension to a value derived using the first distance, a dimension of the current picture and a dimension of the first reference picture.

7-8. (canceled)

9. The method of claim 1, wherein selecting the candidate dimension from a set of two or more candidate dimensions comprises:
comparing the first candidate dimension to the second candidate dimension; and
i) as a result of determining that the first candidate dimension is larger than the second candidate dimension, selecting the first candidate dimension;
ii) as a result of determining that the second candidate dimension is larger than the first candidate dimension, selecting the second candidate dimension; or
iii) as a result of determining that the first candidate dimension is equal to the second candidate dimension, selecting either the first candidate dimension or the second candidate dimension.

10. A method for creating an extended picture area for a current picture comprising a picture boundary block coded with a single motion vector, the method comprising:
based on the motion vector, determining a position of a reference block, wherein the reference block is located within a reference picture;
determining a distance, the distance being a distance from a boundary of the reference block to a corresponding boundary of the reference picture;
based on the distance, determining a dimension for a picture padding block within the extended picture area;
determining whether the dimension is greater than zero; and
ias a result of determining that the dimension is greater than zero, determining at least one sample for the picture padding block based on the motion vector.

11. The method of claim 10, wherein the method further comprises:
setting a first dimension of the padding block equal to the determined dimension; and
setting a second dimension of the padding block.

12. The method of claim 10, wherein determining the dimension comprises setting the dimension to 0 as a result of determining that the resolution of the current picture is different than the resolution of the reference picture.

13. The method of claim 10, wherein determining the dimension comprises setting the dimension to 0 as a result of i) determining that the width of the current picture is different than the width of the reference picture and ii) determining that the picture boundary block has its left or right boundary colliding with a boundary of the current picture.

14. The method of claim 10, wherein determining the dimension comprises setting the dimension to 0 as a result of i) determining that the height of the current picture is different than the height of the reference picture and ii) determining that the picture boundary block has its top or bottom boundary colliding with a boundary of the current picture.

15. The method of claim 10, wherein determining the dimension comprises setting the dimension to a value derived using the distance, a dimension of the current picture, and a dimension of the reference picture.

16-29. (canceled)

30. A non-transitory computer readable storge medium storing a computer program comprising instructions which when executed by processing circuitry of an apparatus causes the apparatus to perform the method of claim 1.

31. A non-transitory computer readable storge medium storing a computer program comprising instructions which when executed by processing circuitry of an apparatus causes the apparatus to perform the method of claim 10.

32. An apparatus, the apparatus comprising:
processing circuitry; and
a non-transitory computer readable storge medium storing a computer program comprising instructions which when executed by the processing circuitry causes the apparatus to perform the method of claim 1.

33. The apparatus of claim 32, wherein determining the first candidate dimension comprises setting the first candidate dimension to 0 as a result of determining that the resolution of the current picture is different than the resolution of the first reference picture.

34. An apparatus, the apparatus comprising:
processing circuitry; and
a non-transitory computer readable storge medium storing a computer program comprising instructions which when executed by the processing circuitry causes the apparatus to perform the method of claim 10.

35. The apparatus of claim 34, wherein determining the dimension comprises setting the dimension to 0 as a result of i) determining that the width of the current picture is different than the width of the reference picture and ii) determining that the picture boundary block has its left or right boundary colliding with a boundary of the current picture.
